(19) United States
(12) Patent Application Publication
(10) Pub. No.: US 2011/0219340 A1
(43) Pub. Date: Sep. 8, 2011

(54) SYSTEM AND METHOD FOR POINT, SELECT AND TRANSFER HAND GESTURE BASED USER INTERFACE

(76) Inventors: Vinod PATHANGAY, Bangalore (IN); Anbumani Subramanian, Bangalore (IN)

(21) Appl. No.: 12/769,654

(22) Filed: Apr. 29, 2010

(30) Foreign Application Priority Data
Mar. 3, 2010 (IN) 556/CHE/2010

(51) Int. Cl. G06F 3/01

(52) U.S. Cl. 715/863

(57) ABSTRACT

A system and method for a point, select and transfer hand gesture based user interface is disclosed. In one embodiment, a depth image of a hand gesture is captured using an in-front camera substantially on a frame by frame basis within a predefined interaction volume. Also, a nearest point of the hand gesture to a display screen of a display device is found using a substantially nearest depth value in the captured depth image for each frame. Further, an image-to-screen mapping of the captured depth image and the found nearest point to the display screen is performed upon validating the found nearest point as associated with the hand for each frame. Moreover, one of select options displayed on the display screen is pointed and selected when the substantially nearest depth value is within one or more predetermined threshold ranges, and based on the outcome of the image-to-screen mapping.

### RELATED APPLICATIONS

Benefit is claimed under 35 U.S.C. 119(a)-(d) to Foreign application Serial No. 556/CHE/2010 entitled “SYSTEM AND METHOD FOR POINT, SELECT AND TRANSFER HAND GESTURE BASED USER INTERFACE” by Hewlett-Packard Development Company, L.P., filed on Mar. 3, 2010, which is herein incorporated in its entirety by reference for all purposes.

### BACKGROUND

In the pursuit of human-computer interface (HCI) beyond touch-based interface, hand-based gestures, such as those created by the movement of a hand, are being considered as the next mode of interaction. Such hand based gestures are sometimes preferred over a touch-based interface, especially when users like to avoid touching a computer display surface, as in the case of a public-display terminal due to concerns about infections through touching or in a greasy-hand scenario due to concerns about leaving messy imprints on the computer display surface.

There are numerous gesture based recognition systems and techniques for HCI. Majority of these systems use a computer vision system to acquire an image of a user for the purpose of enacting a user input function. In a known system, a user may point at one of a plurality of selection options on a display. The system using one or more image acquisition devices, such as a single image camera or a motion image camera, acquires one or more images of the user pointing at the one of the plurality of selection options. Utilizing these one or more images, the system determines an angle of the pointing. The system then utilizes the angle of pointing, together with determined distance and height data, to determine which of the plurality of selection options the user is pointing to. These systems all have a problem of inaccurately determining the intended selection option in that the location of the selection options in a given display must be precisely known for the system to determine the intended selection option. Further these systems have problems in accurately determining the precise angle of pointing, height and the like that is required for making a reliable determination.

There are other numerous gesture based interaction systems that use depth data obtained using time-to-flight based infra-red depth sensors. However, these systems are typically, designed for specific applications, such as gaming, entertainment, healthcare and so on. Further, some of these systems require carrying a remote control like device.

### BRIEF DESCRIPTION OF THE DRAWINGS

Various embodiments are described herein with reference to the drawings, wherein:

FIG. 1 illustrates a computer implemented flow diagram of an exemplary method for a point, select and transfer hand gesture based user interface system, according to one embodiment;

FIG. 2A illustrates a red, green and blue (RGB) image obtained from an in-front camera disposed around a display device, according to one embodiment;

FIG. 2B illustrates a depth image captured by the in-front camera disposed around the display device, according to one embodiment;

FIG. 3 illustrates a schematic representation of a pointing hand gesture interaction with a point, select, and transfer hand gesture based user interface system, according to one embodiment;

FIG. 4 illustrates a schematic representation of a selecting hand gesture interaction with the point, select, and transfer hand gesture based user interface system, according to one embodiment;

FIG. 5 illustrates a computer implemented flow diagram of an exemplary method of transferring digital content from a source location to a destination location in a display screen of the display device, according to another embodiment;

FIGS. 6A through 6D illustrate screenshots showing transfer of digital content from a source location to a destination location located on the display screen of the display device using various hand gestures, according to one embodiment;

FIG. 7 illustrates a computer implemented flow diagram of an exemplary method of transferring digital content from a source device to a destination device, according to yet another embodiment;

FIGS. 8A through 8D illustrate screenshots showing transfer of digital content from a computer to a mobile device using various hand gestures, according to one embodiment; and

FIG. 9 shows an example of a suitable computing system environment for implementing embodiments of the present subject matter.

The drawings described herein are for illustration purposes only and are not intended to limit the scope of the present disclosure in any way.

### DETAILED DESCRIPTION

A system and method for a point, select and transfer hand gesture based user interface is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

In the document, the terms “user interface” and “human-computer interface” are used interchangeably throughout the document.

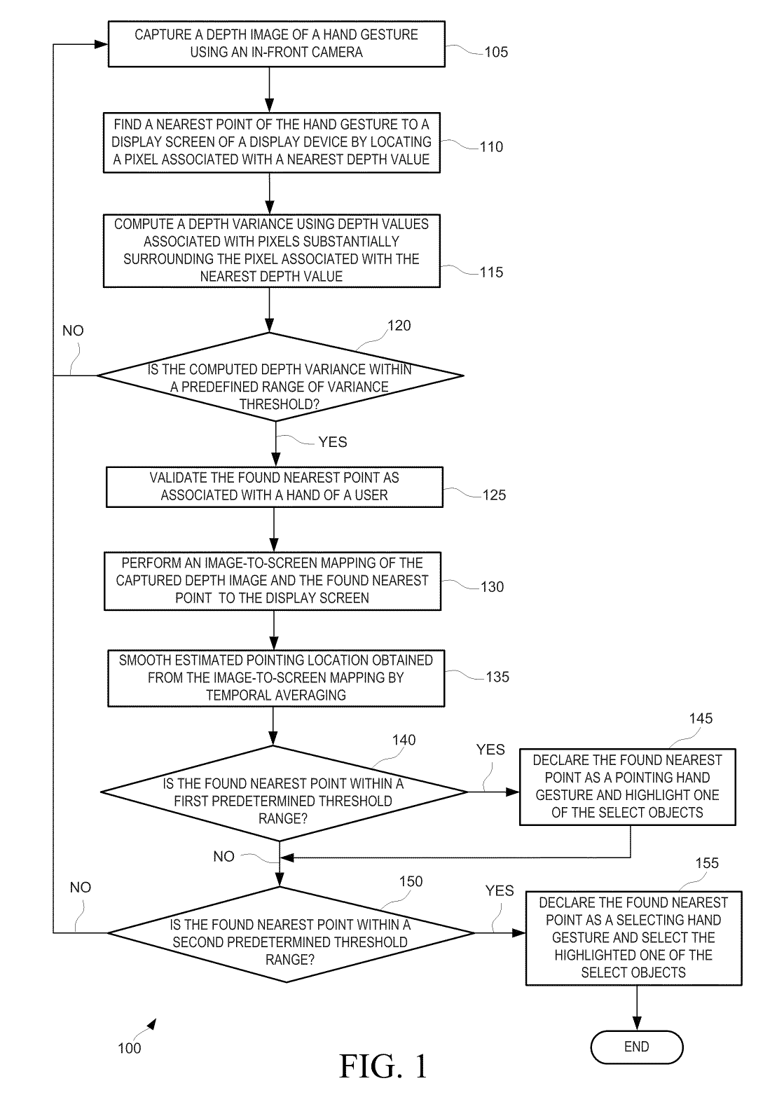

FIG. 1 illustrates a computer implemented flow diagram 100 of an exemplary method for a point, select and transfer hand gesture based user interface system, according to one embodiment. At step 105, a depth image of a hand gesture is captured substantially on a frame by frame basis using an in-front camerain-front camera. The in-front camera may be a depth camera that is substantially disposed around a display device for capturing the depth image of the hand gesture. For example, the in-front camera may be disposed above the display device, below the display device or on side of the display device.

In some embodiments, the in-front camera captures the depth image of the hand gesture made within a predefined interaction volume for performing various operations associated with select objects. The predefined interaction volume may substantially extend in front of a display screen of the display device by a distance approximately in the range of about 0.5 meter to 1 meter. The select objects may be digital content displayed on the display screen of the display device, such as files, folders, and the like, and the various operations associated with the select objects may include selecting, cutting, copying, and pasting of one or more of the select objects using a hand gesture vocabulary.

At step 110, a nearest point of the hand gesture to the display screen is found using a substantially nearest depth value in the captured depth image for each frame. In some embodiments, each pixel in the captured depth image may be assigned a depth value. In these embodiments, a pixel associated with a nearest depth value may be found. If the captured depth image is a non-inverted depth image, then pixels associated with an object nearer to the in-front camera may appear brighter in the captured depth image and hence a pixel with a highest depth value may be considered as the nearest depth value. In case the captured depth image is inverted, pixels associated with the object nearer to the in-front camera may appear darker in the captured depth image and hence a pixel with a lowest depth value may be considered as the nearest depth value. Accordingly, a location (X, Y) of the pixel associated with the nearest depth value in the captured depth image may be found and thus the location may be used to find the nearest point of the hand gesture.

At step 115, a depth variance is computed using depth values associated with pixels substantially surrounding the pixel with the nearest depth value for each frame. At step 120, it is determined whether the computed depth variance is within a predefined range of variance threshold. If the computed depth variance is within the predefined range of variance threshold, then at step 125, the found nearest point is validated as associated with a hand of a user in the captured depth image. The found nearest point may be a tip of a finger or a part of the hand. If the computed depth variance is not within the predefined range of variance threshold, then it implies that the found nearest point is not associated with the hand in the captured depth image and step 105 is repeated.

At step 130, an image-to-screen mapping of the captured depth image and the found nearest point to the display screen is performed. For example, consider that, a depth image is of width Xₘₐₓ and breadth Yₘₐₓ, and the display screen is of width Uₘₐₓ and breadth Vₘₐₓ. Then, an X co-ordinate on the display screen may be computed as:

U=X/Xₘₐₓ*Uₘₐₓ, and

a Y co-ordinate on the display screen may be computed as:

V=Y/Yₘₐₓ*Vₘₐₓ,

where X and Y are the co-ordinates associated with the location of the pixel with the nearest depth value, and U and V are the co-ordinates associated with a location on the display screen. In this manner, the image-to-screen mapping of the captured depth image and the found nearest point to the display screen may be performed by mapping the X and Y co-ordinates associated with the location of the pixel to the U and V co-ordinates associated with the location on the display screen. As a result, an estimated pointing location (U, V) on the display screen may be obtained by performing the image-to-screen mapping of the captured depth image and the found nearest point to the display screen.

At step 135, the estimated pointing location is smoothened by temporal averaging of the estimated pointing location. The estimated pointing location may be smoothened to eliminate jerky pointing due to quantization and to produce a smooth interaction experience for the user. At step 140, it is determined whether the found nearest point is within a first predetermined threshold range. If the found nearest point is within the first predetermined threshold range, then step 145 is performed. At step 145, the found nearest point is declared as a pointing hand gesture and one of the select objects associated with the estimated pointing location is highlighted. If the found nearest point is not within the first predetermined threshold range, then step 150 is performed. At step 150, it is determined whether the found nearest point is within a second predetermined threshold range. In one example embodiment, the user may continue to make a selecting hand gesture following the pointing hand gesture. In such a case, step 150 is performed upon performing the step 145.

If it is determined that the found nearest point is within the second predetermined threshold range, then step 155 is performed, else step 105 is performed. At step 155, the found nearest point is declared as a selecting hand gesture or a pecking hand gesture and the highlighted one of the select objects is selected. The term ‘pecking hand gesture’ may be defined as a pecking action made with a pointed finger within the second predetermined threshold range. In one example embodiment, the selected one of the select objects may be displayed as a full screen mode view on the display screen. In another example embodiment, the selected one of the select objects may be transferred from a source location to a destination location. In one example, the source location and the destination location may be on the display screen of the display device. In another example, the source location may be within the display device with the in-front camera disposed around it, while the destination location may be within another display device such as a desktop, a laptop, a mobile phone, a smart phone and the like, connected to the display device using wired or wireless networks and located within the field-of-view of the in-front camera.

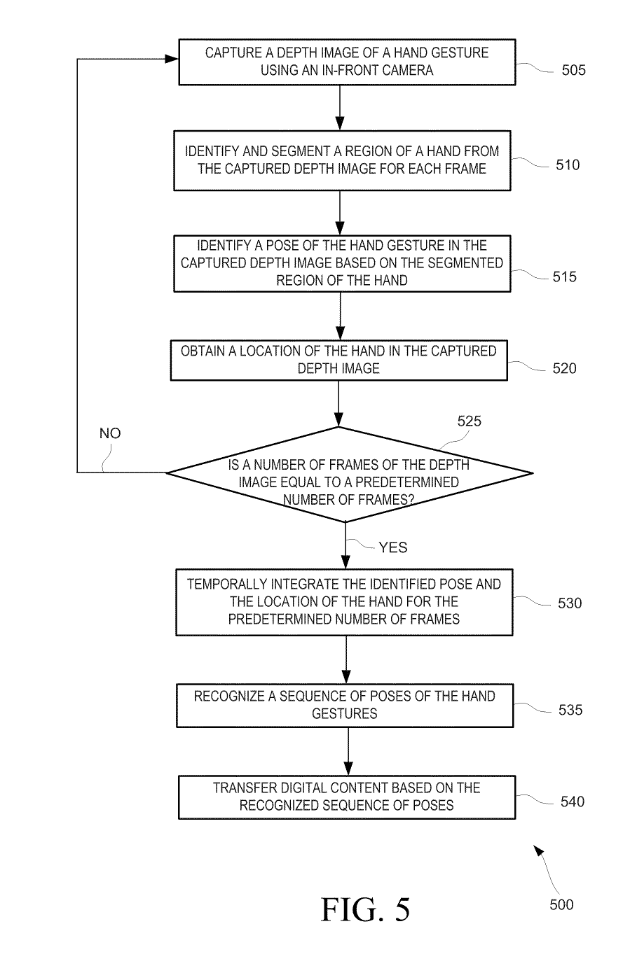

For transferring the one of the select objects, the selected one of the select objects is grabbed using a grabbing hand gesture. The grabbing operation may include copying or cutting the selected one of the select objects. The in-front camera captures a depth image associated with the grabbing hand gesture to perform the grabbing operation. Subsequently, the grabbed one of the select objects may be transferred to the destination location from the source location. In some embodiments, the grabbed one of the select objects may be transferred by moving the forearm with the grabbing hand gesture towards the destination location and then a release hand gesture may paste the grabbed one of the select objects to the destination location. The detailed process of transferring the one or more select objects is described in greater detail in FIGS. 5 through 8.

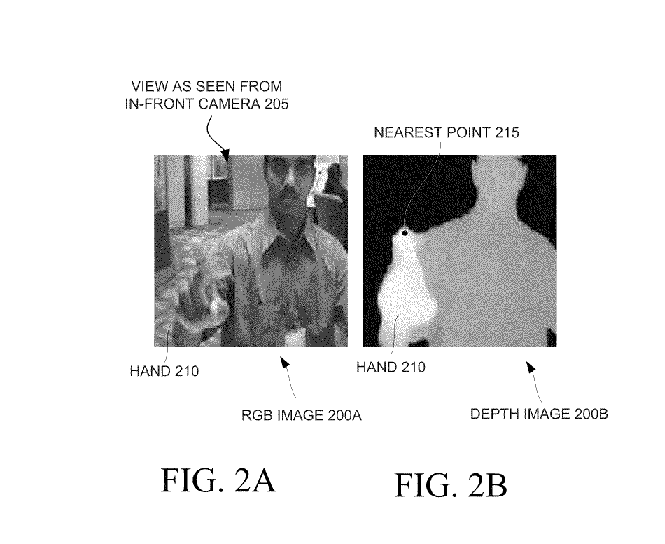

FIG. 2A illustrates a RGB image 200A obtained from an in-front camera disposed around a display device, according to one embodiment. In FIG. 2A, a view 205 of a user making a hand gesture as seen from the in-front camera is shown. In the RGB image 200A, the user points a finger towards a display screen of the display device to interact with the display screen from a distance. FIG. 2B illustrates a depth image 200B captured by the in-front camera disposed around the display device, according to one embodiment. The depth image 200B corresponds to the RGB image 200A as shown in FIG. 2A.

It can be seen from FIG. 2B that, a tip of the finger and other parts of the hand 210 are closer to the in-front camera and hence appear brighter in the depth image 200B. Based on this, a pixel having a brightest depth value in the depth image 200B may be found. Accordingly, a nearest point of the hand gesture may then be found using the location of the pixel with the brightest depth value, as described in step 110 of FIG. 1.

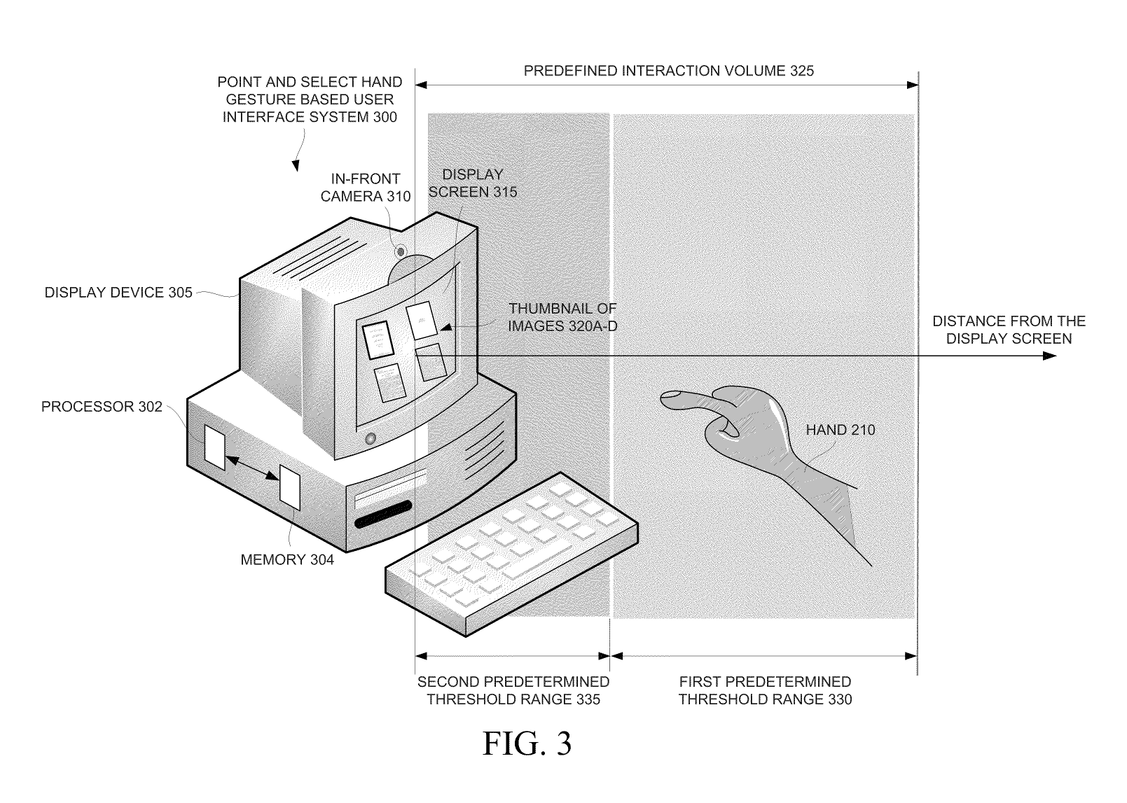

FIG. 3 illustrates a schematic representation of a pointing hand gesture interaction with a point, select and transfer hand gesture based user interface system 300, according to one embodiment. The point, select and transfer hand gesture based user interface system 300 includes a processor 302, a display device 305 coupled to the processor 302, memory 304 operatively coupled to the processor 302, and an in-front camera 310 disposed on top of the display device 305. The display device 305 includes a display screen 315 and is designed to display select objects, such as thumbnails of images 320A-D. The memory may have instructions to enable a point, select and transfer hand gesture based user interface based on a hand gesture vocabulary.

In an example operation, the in-front camera 310 may capture the depth image 200B of a gesture made by the hand 210 within a predefined interaction volume 325. As shown in FIG. 3, the predefined interaction volume 325 is subdivided into a first predetermined threshold range 330 and a second predetermined threshold range 335. The processor 302 may then find a nearest point of the hand gesture to the display screen 315 using a substantially nearest depth value in the captured depth image 200B. For example, a location of a pixel with the nearest depth value may be taken as the nearest point of hand gesture, for example, the nearest point of hand gesture 215. Further, the processor 302 may validate the found nearest point as associated with the hand 210 using a heuristic approach for each frame.

In some embodiments, the processor 302 may validate the found nearest point 215 as associated with the hand 210 if a depth variance is within a predefined range of variance threshold. In these embodiments, the processor 302 may compute the depth variance using depth values associated with pixels substantially surrounding the pixel with the nearest depth value for each frame. Upon validation of the hand 210, the processor 302 may perform an image-to-screen mapping of the found nearest point 215 to the display screen 315.

The processor 302 then determines whether the found nearest point 215 is within the first predetermined threshold range 330 or within the second predetermined threshold range 335. In the example embodiment illustrated in FIG. 3, the found nearest point 215 is within the first predetermined threshold range 330 and hence the processor 302 declares that the hand gesture is a pointing hand gesture. Accordingly, the processor 302 highlights the thumbnail of image 320A based on outcome of image-to-screen mapping of the found nearest point with the display screen 315.

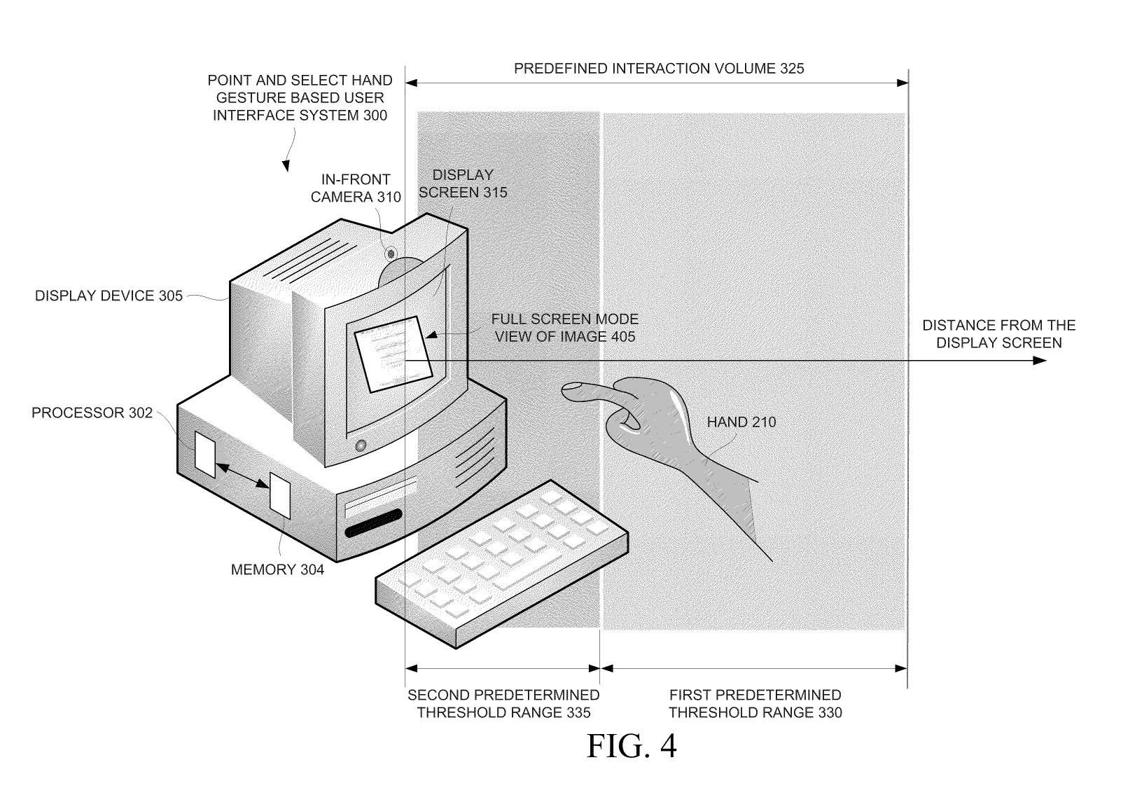

FIG. 4 illustrates a schematic representation of a selecting hand gesture interaction with the point, select and transfer hand gesture based user interface system 300, according to one embodiment. When a selecting hand gesture is made by the user, the processor 302 may determine whether the found nearest point 215 is within the second predetermined threshold range 335. Accordingly, the processor 302 may declare that the hand gesture is a selecting hand gesture or a pecking hand gesture, as illustrated in FIG. 4. As a result, the processor 302 opens the highlighted thumbnail of image 320A to display a full screen mode view 405 on the display screen 315 or returns from the full screen mode view 405 to a thumbnail view.

FIG. 5 illustrates a computer implemented flow diagram 500 of an exemplary method of transferring digital content from a source location to a destination location in a display screen of a display device, according to another embodiment. At step 505, a depth image of a hand gesture is captured using an in-front camera substantially on a frame by frame basis. At step 510, a region of the hand is identified and segmented from the captured depth image of the hand gesture for each frame. In some embodiments, the hand region may be segmented based on depth information obtained from the depth image of the hand gesture.

At step 515, a pose of the hand gesture in the captured depth image is identified based on the segmented region of the hand. For example, the pose of the hand gesture may be a select pose, a grab pose or a release pose. In some embodiments, the pose of the hand gesture is identified using a representation or a feature of the region of the hand. At step 520, a location of the hand associated with the pose of the hand gesture in the captured depth image is obtained from the segmented region of the hand.

At step 525, it is determined whether a number of frames associated with the captured depth image is equal to a predetermined number of frames. The determination in step 525 may be performed to determine a length of time window as hand gestures related to select, copy/cut and paste actions are performed by the user at a coarser time intervals as compared with a video frame rate. If it is determined that the number of frames associated with the captured depth image is not equal to the predetermined number of frames, then step 505 is repeated. If it is determined that the number of frames associated with the depth image is equal to a predetermined number of frames, then step 530 is performed.

At step 530, the identified pose of the hand gesture and the location of the hand are temporally integrated for the predetermined number of frames. The temporal integration may be performed using an averaging time window. At step 535, a sequence of poses of the hand gestures, such as point, grab, and release, is recognized based on the temporally integrated pose of the hand gesture and the location of the hand. In one example embodiment, the sequence of poses is recognized using a finite state machine. At step 540, the digital content is transferred from the source location to the destination location in the display screen of the display device by executing actions corresponding to the recognized sequence of poses.

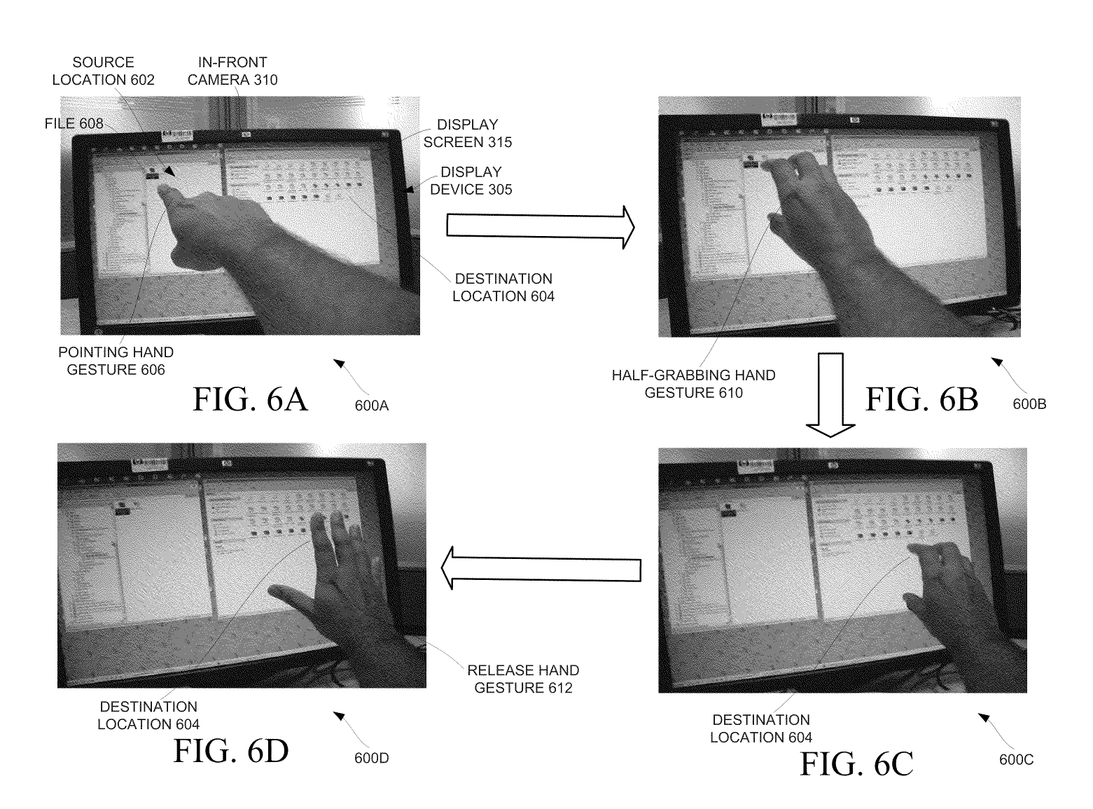

FIGS. 6A through 6D illustrate screenshots 600A-D showing transfer of digital content from a source location 602 to a destination location 604 located on the display screen 315 of the display device 305 using various hand gestures, according to one embodiment. As shown in FIG. 6A, a user in front of the in-front camera 310, disposed around the display device 305, makes a pointing hand gesture 606 to select a file 608 in the source location 604 on the display screen 315. For example, the pointing hand gesture 606 may correspond to pointing hand with a finger extended towards the location of the file 608. In one example embodiment, the file 608 may be selected when the found nearest point of the pointing hand gesture 606 is within one or more predetermined threshold ranges and based on the outcome of the image-to-screen mapping, as discussed in FIG. 1.

Following the selection of the file 608, the user performs a half-grabbing hand gesture 610 towards the location of the selected file 608 on the display screen 315 to copy the selected file 608, as shown in FIG. 6B. In an alternate embodiment, the selected file 608 can be cut from the source location 602 by making a full-grabbing hand gesture towards the location of the selected file 608 in the source location 602. For example, the half-grabbing hand gesture 610 may correspond to half closing of the fist towards the location of the selected file 608, whereas the full-grabbing hand gesture may correspond to fully closing the fist towards the location of the selected file 608.

Further, the user moves his/her hand with the half closed fist towards the destination location 604 on the display screen 315 as shown in FIG. 6C. Finally, as shown in FIG. 6D, the user makes a release hand gesture 612 towards the destination location 604 such that the copied file 608 is pasted in the destination location 604. For example, the release hand gesture 612 may correspond to opening of the half/fully closed fist to show the palm towards the destination location 604.

In one example embodiment, the copied file 608 may be transferred when the found nearest point of the release hand gesture 612 is within one or more predetermined threshold ranges and based on the outcome of the image-to-screen mapping, as discussed in FIG. 1. It should be noted that, the pointing hand gesture 606, the half-grabbing hand gesture 610, and the release hand gesture 612 may be performed within the predefined interaction volume 325 for transferring the file 608 from the source location 602 to the destination location 604.

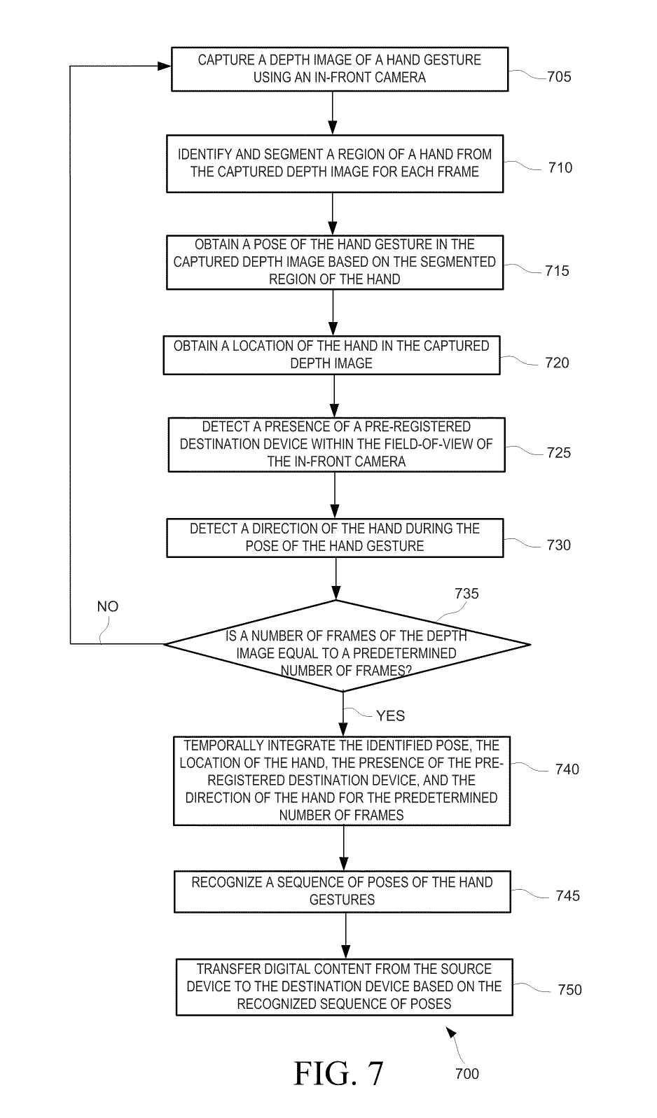

FIG. 7 illustrates a computer implemented flow diagram 700 of an exemplary method of transferring digital content from a source device to a destination device, according to yet another embodiment. For example, the source device may be a display device, such as a personal computer or a laptop around which an in-front camera is disposed. The destination device may be another personal computer, another laptop, a smart phone, a music player, a camera, a media center, a television set and the like, connected to the source device through wired or wireless network. Further, the destination device is pre-registered with the source device and is located within the field-of-view of the in-front camera. At step 705, a depth image of a hand gesture is captured using the in-front camera substantially on a frame by frame basis.

At step 710, a region of the hand is identified and segmented from the captured depth image of the hand gesture for each frame. In some embodiments, the hand region may be segmented based on depth information obtained from the depth image of the hand gesture. At step 715, a pose of the hand gesture in the captured depth image is obtained based on the segmented region of the hand. For example, the pose of the hand gesture may be a select pose, a grab pose or a release pose. In some embodiments, the pose of the hand gesture is identified using a representation or a feature of the region of the hand. At step 720, a location of the hand associated with the pose of the hand gesture in the captured depth image is obtained from the segmented region of the hand.

At step 725, a presence of a pre-registered destination device is detected within the field-of-view of the in-front camera. At step 730, a direction of the hand during the pose of the hand gesture is detected. For example, it may be detected whether the hand is directed towards the source device or towards the destination device.

At step 735, it is determined whether a number of frames associated with the captured depth image is equal to a predetermined number of frames. The determination in step 735 is performed to determine a length of time window as hand gestures related to select, copy/cut and paste actions are performed by the user at a coarser time intervals as compared with a video frame rate. If it is determined that the number of frames associated with the captured depth image is not equal to the predetermined number of frames, then step 705 is repeated. If it is determined that the number of frames associated with the captured depth image is equal to a predetermined number of frames, then, step 740 is performed.

At step 740, the identified pose of the hand gesture, the location of the hand, presence of the pre-registered destination device and the direction of the hand are temporally integrated for the predetermined number of frames. The temporal integration may be performed using an averaging time window. At step 745, a sequence of poses of the hand gestures, such as point, grab, and release, is recognized based on the temporally integrated pose of the hand gesture and the location of the hand over the time window. In one example embodiment, the sequence of poses is recognized using a finite state machine. At step 750, the digital content is transferred from the source device to the destination device by executing actions corresponding to the recognized sequence of poses.

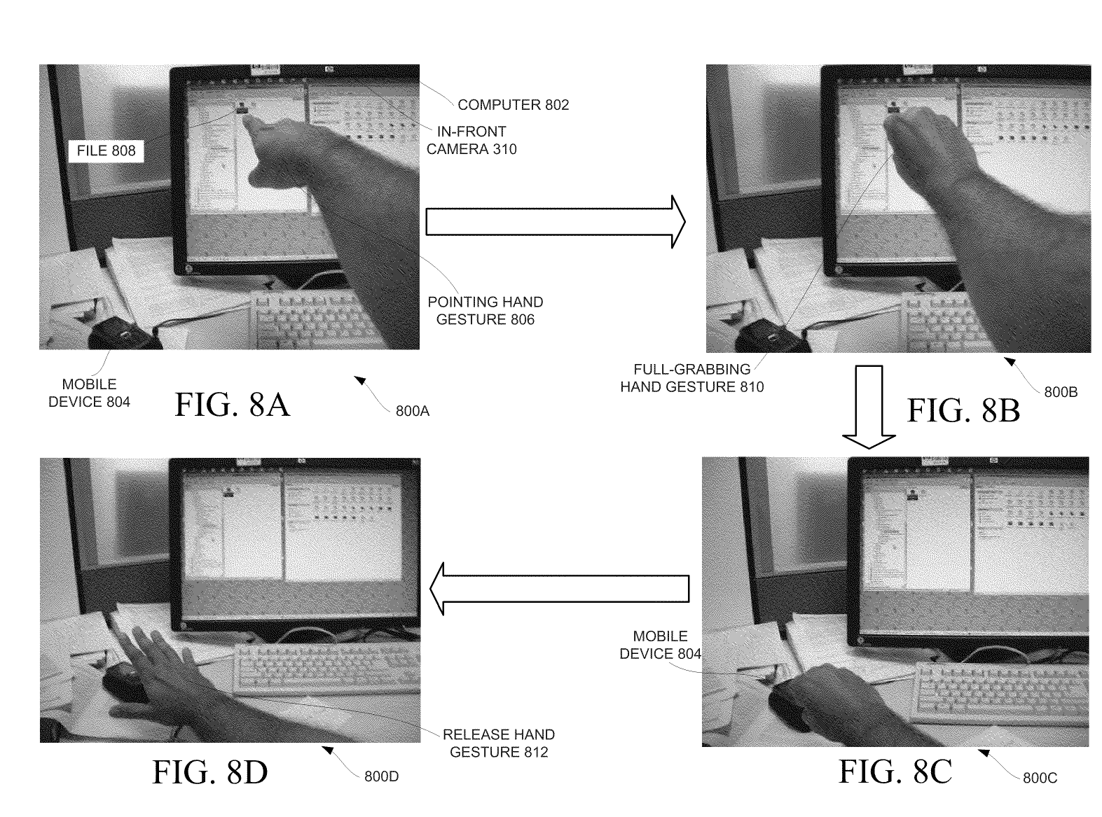

FIGS. 8A through 8D illustrate screenshots 800A-D showing transfer of digital content from a computer 802 to a mobile device 804 using various hand gestures, according to one embodiment. In this example, the mobile device 804 is pre-registered with the computer 802 and is placed within the field-of-view of the in-front camera 310 disposed around the computer 802. As shown in FIG. 8A, a user in front of the in-front camera 310 makes a pointing hand gesture 806 to select a file 808 located on the computer 802. For example, the pointing hand gesture 806 may correspond to pointing hand with a finger extended towards the location of the file 808. In one example embodiment, the file 808 may be selected when the found nearest point of the pointing hand gesture 806 is within one or more predetermined threshold ranges and based on the outcome of the image-to-screen mapping, as discussed in FIG. 1.

Following the selection of the file 808, the user performs a full-grabbing hand gesture 810 towards the location of the selected file 808 on the computer 802 to cut the selected file 808, as shown in FIG. 8B. In an alternate embodiment, the selected file 808 may be copied from the computer 802 by making a half-grabbing hand gesture towards the location of the selected file 808 on the computer 802. For example, the half-grabbing hand gesture may correspond to a half closing of fist towards the location of the selected file 808, whereas the full-grabbing hand gesture 810 may correspond to fully closing the fist towards the location of the selected file 808.

Further, the user moves his/her hand with the fully closed fist towards the mobile device 804 as shown in FIG. 8C. Finally, as shown in FIG. 8D, the user makes a release hand gesture 812 towards the mobile device 804 such that the cut file 808 is pasted on to the mobile device 804. For example, the release hand gesture 812 may correspond to opening of the half/fully closed fist to show the palm towards the mobile device 804. In one example embodiment, the cut file 808 may be transferred when the found nearest point of the release hand gesture 812 is within one or more predetermined threshold ranges and based on the outcome of the image-to-screen mapping, as discussed in FIG. 1. It should be noted that, the pointing hand gesture 806, the full-grabbing hand gesture 810, and the release hand gesture 812 may be performed within the predefined interaction volume 325 for transferring the file 808 from the computer 802 to the mobile device 804.

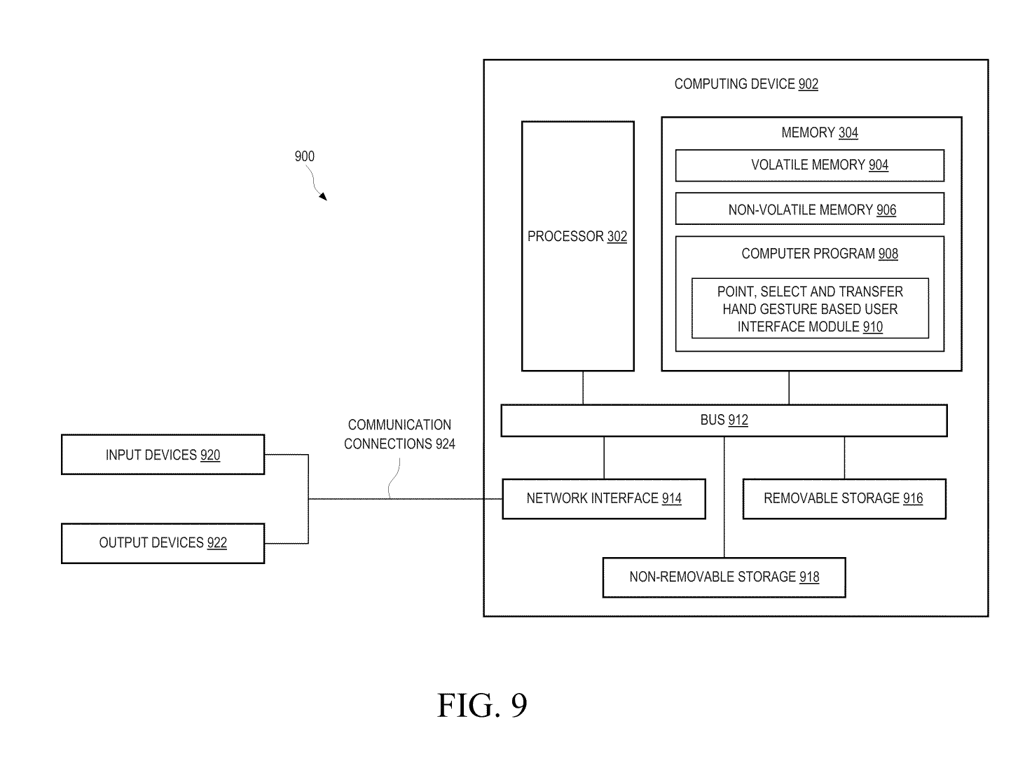

FIG. 9 shows an example of a suitable computing system environment 900 for implementing embodiments of the present subject matter. FIG. 9 and the following discussion are intended to provide a brief, general description of the suitable computing environment 900 in which certain embodiments of the inventive concepts contained herein may be implemented.

A general computing device 902, such as the point, select and transfer hand gesture based user interface system 300, in the form of a personal computer, or a laptop may include the processor 302, the memory 304, a removable storage 916, and a non-removable storage 918. The computing device 902 additionally includes a bus 912 and a network interface 914. The computing device 902 may include or have access to the computing environment 900 that includes one or more user input devices 920, one or more output devices 922, and one or more communication connections 924 such as a network interface card or a universal serial bus connection.

The one or more user input devices 920 may be the in-front camera 310, keyboard, trackball, and the like. The one or more output devices 926 may be the display device 305 of the personal computer, or the laptop. The communication connection 924 may include a local area network, a wide area network, and/or other networks.

The memory 304 may include volatile memory 904 and non-volatile memory 906. A variety of computer-readable storage media may be stored in and accessed from the memory elements of the computing device 902, such as the volatile memory 904 and the non-volatile memory 906, the removable storage 916 and the non-removable storage 918. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 302, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 904 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 302 of the computing device 902. For example, a computer program 908 may include machine-readable instructions capable of providing a point, select and transfer hand gesture based user interface, according to the teachings and herein described embodiments of the present subject matter. In one embodiment, the computer program 908 may be included on a compact disk-read only memory (CD-ROM) and loaded from the CD-ROM to a hard drive in the non-volatile memory 906. The machine-readable instructions may cause the computing device 902 to encode according to the various embodiments of the present subject matter.

As shown, the computer program 908 includes a point, select and transfer hand gesture based user interface module 910 to capture a depth image 200B of a hand gesture using the in-front camera 310 substantially on a frame by frame basis within the 325 predefined interaction volume. The in-front camera 310 is substantially disposed around the display device 305 which is designed to display a plurality of select options. Further, the point, select and transfer hand gesture based user interface module 910 may find a nearest point of the hand gesture to the display screen 315 of the display device 305 using a substantially nearest depth value in the captured depth image 200B for each frame.

In addition, the point, select and transfer hand gesture based user interface module 910 may perform an image-to-screen mapping of the captured depth image 200B and the found nearest point to the display screen 315 upon validating the found nearest point as associated with the hand for each frame. Moreover, the point, select and transfer hand gesture based user interface module 910 may point and select one of the plurality of displayed select options on the display screen 315 of the display device 305 when the nearest depth value is within one or more predetermined threshold values or ranges, and based on the outcome of the image-to-screen mapping.

In one exemplary implementation, the point, select and transfer hand gesture based user interface module 910 may point and select digital content displayed on the display screen 315 of the source display device 305 when the nearest depth value associated with a grabbing hand gesture is within one or more predetermined threshold values or ranges, and based on the outcome of the image-to-screen mapping. The point, select and transfer hand gesture based user interface module 910 may then grab the digital content upon pointing and selecting the digital content displayed on the display screen 315. Moreover, the point, select and transfer hand gesture based user interface module 910 may transfer the digital content to a destination display device when the nearest depth value associated with a release hand gesture is within one or more predetermined threshold values or ranges, and based on the outcome of the image-to-screen mapping.

For example, the point, select and transfer hand gesture based user interface module 910 described above may be in the form of instructions stored on a non-transitory computer-readable storage medium. The non-transitory computer-readable storage medium having the instructions that, when executed by the computing device 902, may cause the computing device 902 to perform the one or more methods described in FIGS. 1-9.

In various embodiments, the methods and systems described in FIGS. 1 through 9 may enable a hand gesture-based interaction for pointing and selection of a select object displayed on a display screen of a display device from a distance using a bare hand. The methods and systems also enable a hand gesture based interaction for transferring digital content, such as photos, music, documents and so on, from one location to another location in the same device or from one device to another device.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A computer implemented method for a point, select and transfer hand gesture based user interface, comprising:
capturing a depth image of a hand gesture using an in-front camera substantially on a frame by frame basis within a predefined interaction volume and wherein the in-front camera is substantially disposed around a display device and wherein the display device is designed to display a plurality of select options;
finding a nearest point of the hand gesture to a display screen of the display device using a substantially nearest depth value in the captured depth image for each frame;
performing an image-to-screen mapping of the captured depth image and the found nearest point to the display screen upon validating the found nearest point as associated with the hand for each frame; and
pointing and selecting one of the plurality of displayed select options on the display screen of the display device when the substantially nearest depth value is within one or more predetermined threshold values or ranges, and based on the outcome of the image-to-screen mapping.

2. The method of claim 1, further comprising:
validating whether the found nearest point is associated with a hand in the captured depth image using a heuristic approach for each frame; and
pointing and selecting one of the plurality of displayed select options on the display screen of the computer when the substantially nearest depth value is within one or more predetermined threshold values or ranges, and based on the outcome of the image-to-screen mapping and validating the found nearest point as associated with the hand for each frame.

3. The method of claim 1, wherein the predefined interaction volume substantially extends in front of the display screen by a distance that is approximately in the range of about 0.5 meter to 1 meter.

4. The method of claim 2, wherein finding the nearest point to the display screen using the substantially nearest depth value in the captured depth image for each frame comprises:
finding a pixel associated with the substantially nearest depth value in the captured depth image for each frame.

5. The method of claim 3, wherein validating whether the found nearest point is associated with the hand in the captured depth image using the heuristic approach for each frame comprises:
computing a depth variance using depth values associated with pixels substantially surrounding the pixel associated with the substantially nearest depth value for each frame; and
if the computed depth variance is within a predefined range of variance threshold, then validating the found nearest point as associated with the hand in the captured depth image for each frame.

6. The method of claim 1, wherein performing the image-to-screen mapping of the captured depth image and the found nearest point to the display screen upon validating the found nearest point as associated with the hand for each frame further comprises:
smoothening an estimated pointing location on the display screen by temporal averaging of the estimated pointing location upon performing the image-to-screen mapping of the captured depth image and the found nearest point to the display screen.

7. The method of claim 5, wherein pointing and selecting the one of the plurality of displayed select options on the display screen of the display device when the substantially nearest depth value is within the one or more predetermined threshold values or ranges, and based on the outcome of the image-to-screen mapping, comprises:
determining whether the found nearest point associated with the substantially nearest depth value is within a first predetermined threshold range or within a second predetermined threshold range, wherein the found nearest point is a tip of a finger or a part of a hand;
if the found nearest point is within the first predetermined threshold range then declaring the found nearest point as a pointing hand gesture and highlighting the one of the plurality of select options displayed on the display screen based on the outcome of the image-to-screen mapping; and
if the found nearest point is within the second predetermined threshold range then declaring the found nearest point as a selecting hand gesture and selecting the highlighted one of the plurality of select options displayed on the display screen.

8. The method of claim 7, wherein pointing and selecting the one of the plurality of displayed select options on the display screen of the display device when the substantially nearest depth value is within the one or more predetermined threshold values or ranges, and based on the outcome of the image-to-screen mapping, further comprising:
if the found nearest point is outside the first predetermined threshold range and the second predetermined threshold range, then doing nothing on the display screen.

9. The method of claim 1, wherein the in-front camera comprises a depth camera disposed in a location selected from the group consisting of above the display device, below the display device, and on side of the display device.

10. The method of claim 1, wherein, in finding a nearest point of the hand gesture, the substantially nearest depth value comprises a highest depth value or a lowest depth value.

11. The method of claim 1, wherein pointing and selecting the one of the plurality of displayed select options on the display screen of the display device, comprises:
pointing and selecting digital content displayed on a display screen of a source display device when the substantially nearest depth value associated with a grabbing hand gesture is within the one or more predetermined threshold values or ranges, and based on the outcome of the image-to-screen mapping;
grabbing the digital content upon pointing and selecting the digital content displayed on the display screen; and
transferring the digital content to a destination display device when the substantially nearest depth value associated with a release hand gesture is within the one or more predetermined threshold values or ranges, and based on the outcome of the image-to-screen mapping.

12. A non-transitory computer-readable storage medium for a point, select and transfer hand gesture based user interface having instructions that, when executed by a computing device, cause the computing device to perform a method comprising:
capturing a depth image of a hand gesture using an in-front camera substantially on a frame by frame basis within a predefined interaction volume and wherein the in-front camera is substantially disposed around a display device and wherein the display device is designed to display a plurality of select options;
finding a nearest point of the hand gesture to a display screen of the display device using a substantially nearest depth value in the captured depth image for each frame;
performing an image-to-screen mapping of the captured depth image and the found nearest point to the display screen upon validating the found nearest point as associated with the hand for each frame; and
pointing and selecting one of the plurality of displayed select options on the display screen of the display device when the substantially nearest depth value is within one or more predetermined threshold values or ranges, and based on the outcome of the image-to-screen mapping.

13. The non-transitory computer-readable storage medium of claim 12, wherein pointing and selecting the one of the plurality of displayed select options on the display screen of the display device, comprises:
pointing and selecting digital content displayed on a display screen of a source display device when the substantially nearest depth value associated with a grabbing hand gesture is within the one or more predetermined threshold values or ranges, and based on the outcome of the image-to-screen mapping;
grabbing the digital content upon pointing and selecting the digital content displayed on the display screen; and
transferring the digital content to a destination display device when the substantially nearest depth value associated with a release hand gesture is within the one or more predetermined threshold values or ranges, and based on the outcome of the image-to-screen mapping.

14. A system for a point, select and transfer hand gesture based user interface, comprising:
a processor;
a display device having a display screen and coupled to the processor, wherein the display device is configured to display a plurality of select options;
an in-front camera disposed substantially around the display device; and
memory operatively coupled to the processor, wherein the memory includes a point, select and transfer hand gesture based user interface module having instructions capable of:
capturing a depth image of a hand gesture using the in-front camera substantially on a frame by frame basis within a predefined interaction volume and wherein the in-front camera is substantially disposed around a display device and wherein the display device is designed to display a plurality of select options;
finding a nearest point of the hand gesture to a display screen of the display device using a substantially nearest depth value in the captured depth image for each frame;
performing an image-to-screen mapping of the captured depth image and the found nearest point to the display screen upon validating the found nearest point as associated with the hand for each frame; and
pointing and selecting one of the plurality of displayed select options on the display screen of the display device when the substantially nearest depth value is within one or more predetermined threshold values or ranges, and based on the outcome of the image-to-screen mapping.

15. The system of claim 14, wherein the point, select and transfer hand gesture based user interface module have further instructions capable of:
pointing and selecting digital content displayed on a display screen of a source display device when the substantially nearest depth value associated with a grabbing hand gesture is within the one or more predetermined threshold values or ranges, and based on the outcome of the image-to-screen mapping;
grabbing the digital content upon pointing and selecting the digital content displayed on the display screen; and
transferring the digital content to a destination display device when the substantially nearest depth value associated with a release hand gesture is within the one or more predetermined threshold values or ranges, and based on the outcome of the image-to-screen mapping.
